(19) United States
(12) Patent Application Publication
(10) Pub. No.: US 2009/0159599 A1
(43) Pub. Date: Jun. 25, 2009

(54) Flame Retardant Storage Device

(76) Inventor: J. Byron Alexander, Berkeley Lake, GA (US)

Correspondence Address: HARSHAW RESEARCH, INC., 210 W. TECUMSEH STREET, OTTAWA, KS, 66067, US

(21) Appl. No.: 11/962,671

(22) Filed: Dec. 21, 2007

(51) Int. Cl. F17C 3/04; B65D 25/28; B65D 45/16; B65D 25/04

(52) U.S. Cl. 220/560.01; 220/772; 220/324; 220/500

(57) ABSTRACT

A flame retardant storage device includes a flame retardant shell having upper and lower ends, front and back faces, and opposed sides. The shell defines an enclosed interior area and includes at least one door for accessing the interior area. The storage device includes a hanger element having a first portion lowerly adjacent the shell upper end and being configured to distribute a hanging force throughout the shell upper end. The hanger element includes a rotatable hook operatively coupled to the first portion and extends upwardly of the shell upper end. Further, the hanger element includes a fixed hook operatively coupled to the first portion and extends upwardly of the shell upper end. The rotatable hook is configured to attach to a generally horizontal pole and rotate at least about ninety degrees relative to the first portion.

### BACKGROUND OF THE INVENTION

This invention relates to fireproof storage devices and, more particularly, to a storage device that may be hung on a door or in a closet and which is configured to store multiple documents and to protect them from the effects of flames.

People often choose to store important documents in a file cabinet for organizational reasons or even in a safe so as to keep them secure from intrusion. Document organizers, storage containers, or even safes are typically stored by sliding them under beds, stacked in a closet, or placed in larger containers like file cabinets, making storage a real problem. However, there is always a risk that such documents or other valuable articles may still become lost, stolen, or destroyed should the locations of the documents be burglarized, damaged, or exposed to a fire.

Various devices have been proposed in the art for storing documents in a fire retardant location. Although assumably effective for their intended purposes, the existing devices still present difficulty in storing large amounts of documents in a conveniently accessible configuration or in a manner that remains substantially out of the way or even hidden when not needed. Further, the existing devices do not provide store a large quantity of documents in a substantially fire retardant environment.

Therefore, it would be desirable to have a storage device having a slim but elongate configuration that may be hung from a door or closet pole such that it maximizes storage capacity without taking up floor space. Further, it would be desirable to have a storage Docket 76357-1-device that remains durable and flexible while being flame retardant so as to prevent or at least delay damage to stored documents if the storage device is exposed to flames.

### SUMMARY OF THE INVENTION

Therefore, a flame retardant storage device according to the present invention includes a flame retardant shell having upper and lower ends, front and back faces, and opposed sides. The shell defines an enclosed interior area and includes at least one access door for accessing the interior area. The storage device also includes a hanger element having a first portion lowerly adjacent the shell upper end and being configured to distribute a hanging force throughout the shell upper end. The hanger element includes a rotatable hook operatively coupled to the first portion and extends upwardly of the shell upper end. Further, the hanger element includes a fixed hook operatively coupled to the first portion and extends upwardly of the shell upper end. The fixed hook is configured to attach to a top end of a door.

The rotatable hook is configured to attach to a generally horizontal pole—such as a closet clothes-hanging pole—and rotate at least about ninety degrees relative to the first portion, whereby the shell rotates between a configuration extending generally perpendicular to the pole and a configuration extending generally parallel to the pole.

Therefore, a general object of this invention is to provide a fire retardant storage device for storing a relatively large quantity of documents in an easily accessible manner.

Another object of this invention is to provide a fire retardant storage device, as aforesaid, that includes a hanging element that enables the device to be hung from a door or closet pole.

Still another object of this invention is to provide a fire retardant storage device, as aforesaid, having a construction that is flexible, durable, and flame retardant.

Yet another object of this invention is to provide a fire retardant storage device, as aforesaid, that is rotatable while hanging between storage and access configurations.

A further object of this invention is to provide a fire retardant storage device, as aforesaid, that is cost-effective to manufacture.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a flame retardant storage device according to a preferred embodiment of the present invention;

FIG. 2 is a perspective view of the storage device as in FIG. 1 with the access doors in an open configuration;

FIG. 3a is another perspective view of the storage device as in FIG. 1;

FIG. 3b is an isolated view on an enlarged scale of a portion of the storage device taken from FIG. 3a, illustrating the access door in a closed configuration;

FIG. 3c is an isolated view on an enlarged scale of a portion of the storage device taken from FIG. 3a, illustrating the access door in an open configuration and using a zipper fastener;

FIG. 4a is another perspective view of the storage device as in FIG. 2;

FIG. 4b is an isolated view on an enlarged scale taken from a portion of FIG. 4a with the access door in an open configuration and in use with a hook and loop fastener;

FIG. 5a is another perspective view of the storage device as in FIG. 1;

FIG. 5b is an isolated view on an enlarged scale taken from a portion of FIG. 5a with a rotatable hook in a first position; and

FIG. 5c is an isolated view on an enlarged scale taken from a portion of FIG. 5a with a rotatable hook in a second position.

### DESCRIPTION OF THE PREFERRED EMBODIMENT

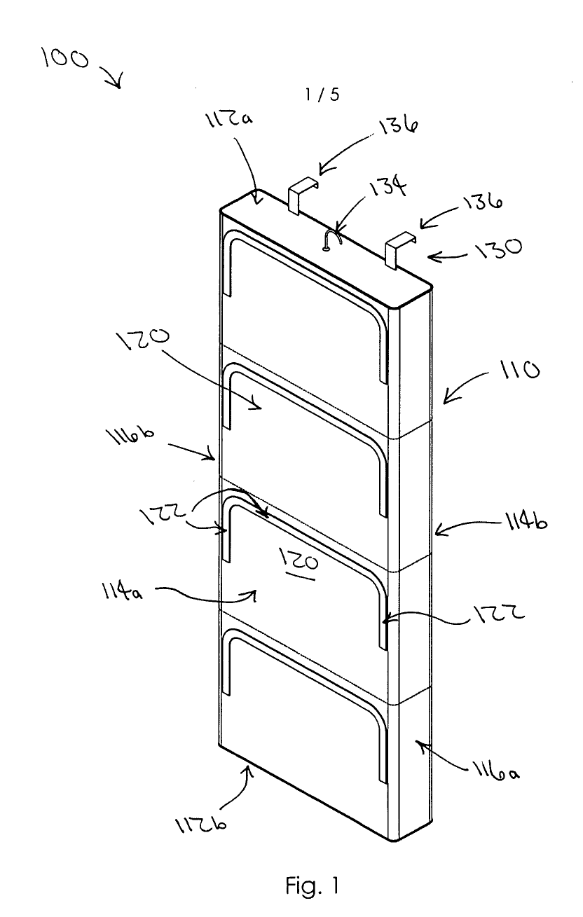

A flame retardant storage device 100 according to the present invention will now be described in detail with reference to FIGS. 1 through 5c of the accompanying drawings. More particularly, according to the current invention, a flame retardant storage device 100 includes a flame retardant shell 110 and a hanger element 130.

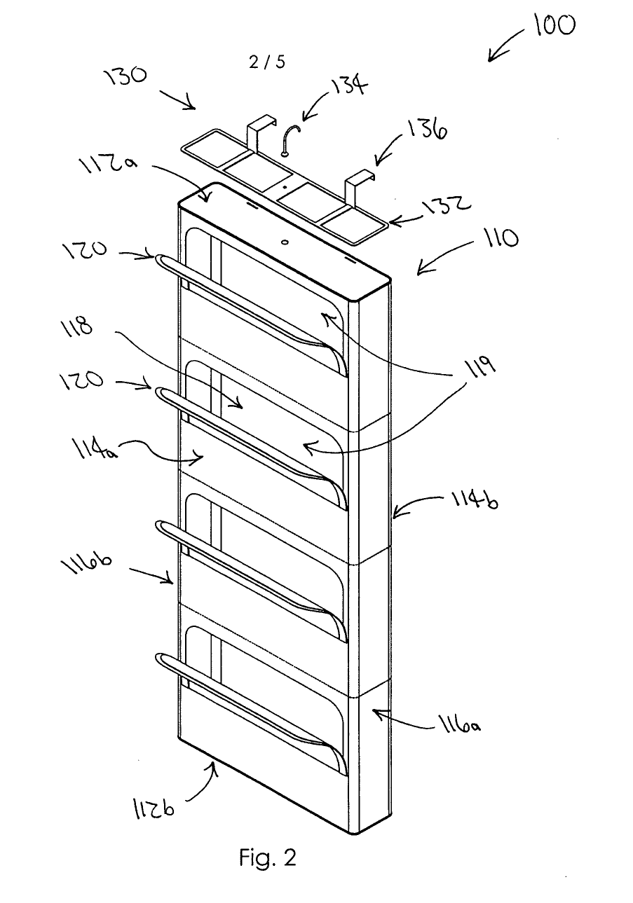

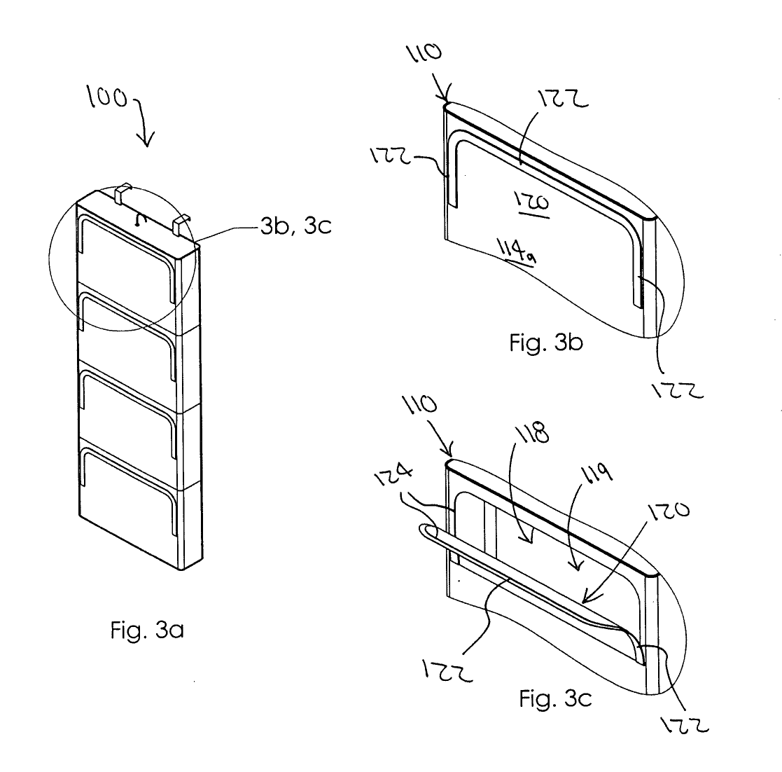

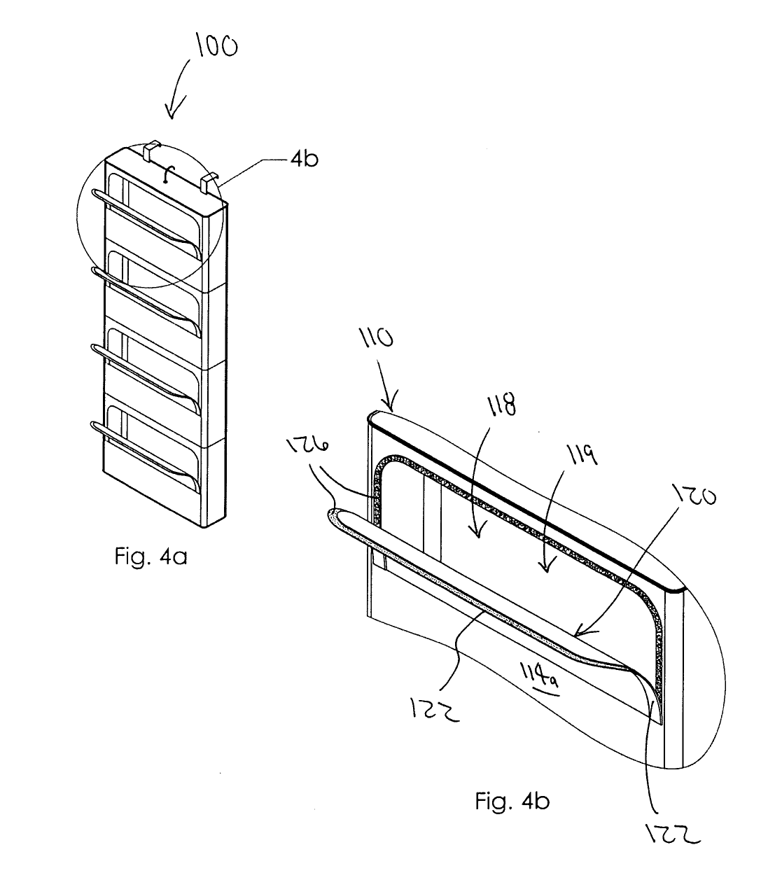

As shown in FIGS. 1 and 2, the shell 110 has upper and lower ends 112a, 112b, front and back faces 114a, 114b, and opposed sides 116a, 116b. The shell 110 defines an enclosed interior area 118 and has at least one door 120 for accessing the interior area 118. The door 120 may be a flap having three sides 122 selectively coupled to the shell front face 114a. A zipper 124 (FIG. 3c) and/or a hook and loop fastener 126 (FIG. 4b) selectively maintain the three sides 122 coupled to the shell front face 114a (FIG. 1) (i.e., at a closed configuration). The shell 110 may be constructed of a durable material that is resistant to fire or coated with a substance that provides fire resistant properties; exemplary materials that may be used include Nomex, Modacrylic, and/or Twaron.

The enclosed area 118 may include a plurality of compartments 119, as shown in FIG. 2. The compartments 119 may each be accessed through a respective door 120, and the compartments 119 may be arranged whereby at least one compartment 119 is upwardly adjacent another compartment 119. In one embodiment, at least one compartment is sized to receive paperwork.

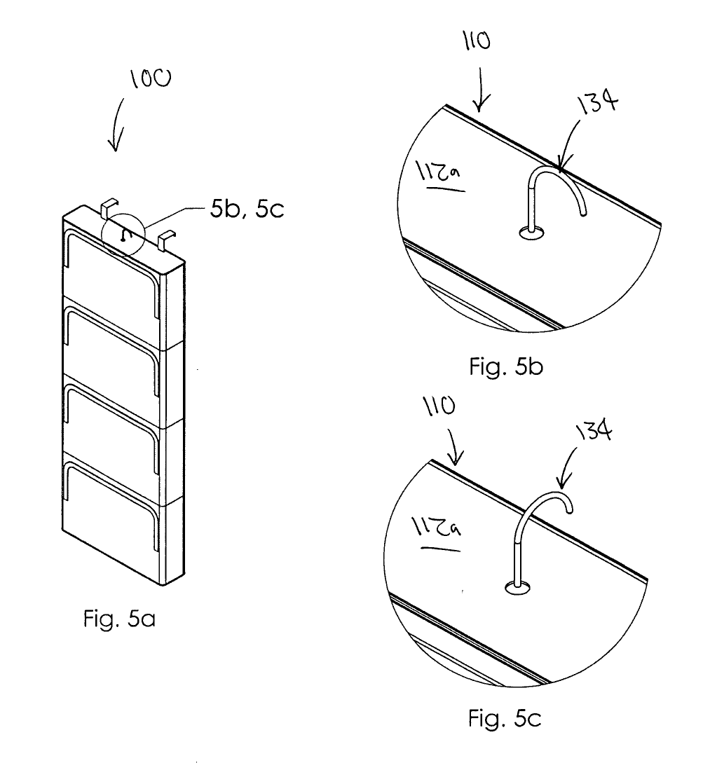

The hanger element 130 has a first portion 132 (FIG. 2) lowerly adjacent the shell upper end 112a. The first portion 132 is configured to distribute a hanging force throughout the shell upper end 112a. A rotatable hook 134 may be operatively coupled to the first portion 132 so that the rotatable hook 134 extends upwardly of the shell upper end 112a, and the rotatable hook 134 may be configured to attach to a generally horizontal pole (e.g., a closet pole) and rotate at least about ninety degrees relative to the first portion 132 (FIGS. 5b and 5c). A fixed hook 136 (FIG. 2) may be operatively coupled to the first portion 132 so that the fixed hook 136 extends upwardly of the shell upper end 112a, and the fixed hook 136 may be configured to attach to a top end of a door (not shown).

In use, the hanger element 130 may be used to attach the shell 110 to a door or a pole (e.g., a closet pole). More particularly, the fixed hook 136 may be placed over the top end of a door to attach the shell 110 to the door, or the rotatable hook 134 may be placed over the pole to attach the shell 110 to the pole. If both the rotatable hook 134 and the fixed hook 136 are provided, the shell 110 may at times be attached to the door and at other times be attached to the closet pole. The door(s) 120 may be opened using the zipper 124 (FIG. 3c) and/or the hook and loop fastener 126 (FIG. 4b) to access the enclosed area 118 (e.g., the compartments 119). If a compartment 119 is sized to receive paperwork as noted above, paperwork may easily and securely be placed in the compartment 119. It should be understood, however, that other items may also or alternately be received in the compartments 119. Once the items are placed in the compartments 119, the doors 120 may be closed by again using the respective zipper 124 and/or hook and loop fastener 126.

As shown in FIG. 1, the shell 110 may have a generally rectangular cross section when viewed from above. In one embodiment, this cross section of the shell 110 is sized to fit inside a closet when the rotatable hook 134 is attached to the closet pole and the shell 110 extends generally perpendicular to the closet pole. Such a configuration may allow the storage device 100 to take up minimal room in a closet when not in use. To access the compartments 119 as discussed above, the hanger element first portion 132 may rotate at least about ninety degrees relative to the rotatable hook 134, causing the shell 110 to rotate between the configuration extending generally perpendicular to the closet pole (FIG. 5b) and a configuration extending generally parallel to the pole (FIG. 5c).

It is understood that while certain forms of this invention have been illustrated and described, it is not limited thereto except insofar as such limitations are included in the following claims and allowable functional equivalents thereof.

1. A flame retardant storage device, comprising:
a shell having upper and lower ends, front and back faces, and opposed sides, said shell defining an enclosed interior area and having a door for accessing said interior area; and
a hanger element having first and second portions, said first portion being lowerly adjacent said shell upper end and being configured to distribute a hanging force throughout said shell upper end, said second portion extending upwardly of said shell upper end and having an attachment configuration;
wherein said shell is flame retardant.

2. The storage device of claim 1, wherein said second portion having an attachment configuration is a fixed hook configured to attach to a top end of a door.

3. The storage device of claim 2, further comprising a rotatable hook operatively coupled to said first portion and extending upwardly of said shell upper end, said rotatable hook being configured to attach to a generally horizontal pole and rotate at least about ninety degrees relative to said first portion.

4. The storage device of claim 1, wherein said second portion having an attachment configuration is a rotatable hook configured to attach to a generally horizontal pole and rotate at least about ninety degrees relative to said first portion.

5. The storage device of claim 4, wherein:
said generally horizontal pole is a closet pole; and
said shell has a generally rectangular cross section sized to fit inside a closet when said shell extends generally perpendicular to said closet pole.

6. The storage device of claim 5, further comprising a fixed hook operatively coupled to said first portion and extending upwardly of said shell upper end, said fixed hook being configured to attach to a top end of a door.

7. The storage device of claim 1, wherein said enclosed interior area includes a plurality of compartments, each said compartment being accessible through a respective door.

8. The storage device of claim 1, wherein at least one of a hook and loop fastener and a zipper selectively maintain said door at a closed configuration.

9. A flame retardant storage device, comprising:
a flame retardant shell having upper and lower ends, front and back faces, and opposed sides, said shell defining an enclosed interior area and having at least one door for accessing said interior area; and
a hanger element having a first portion lowerly adjacent said shell upper end and being configured to distribute a hanging force throughout said shell upper end, a rotatable hook operatively coupled to said first portion and extending upwardly of said shell upper end, and a fixed hook operatively coupled to said first portion and extending upwardly of said shell upper end;
wherein said rotatable hook is configured to attach to a generally horizontal pole and rotate at least about ninety degrees relative to said first portion, whereby said shell rotates between a configuration extending generally perpendicular to said pole and a configuration extending generally parallel to said pole; and
wherein said fixed hook is configured to attach to a top end of a door.

10. The storage device of claim 9, wherein:
said generally horizontal pole is a closet pole; and
said shell has a generally rectangular cross section sized to fit inside a closet when said shell extends generally perpendicular to said closet pole.

11. The storage device of claim 9, wherein:
said enclosed interior area includes a plurality of compartments; and
at least one compartment is sized to receive paperwork.

12. The storage device of claim 11, wherein at least one said compartment is upwardly adjacent another said compartment.

13. The storage device of claim 9, wherein at least one of a hook and loop fastener and a zipper selectively maintain said door at a closed configuration.

14. The storage device of claim 9, wherein said door is a flap having three sides selectively coupled to said shell front face.

15. The storage device of claim 14, wherein at least one of a hook and loop fastener and a zipper selectively maintain said three sides of said flap coupled to said shell front face.

16. A flame retardant storage device, comprising:
a flame retardant shell having upper and lower ends, front and back faces, and opposed sides, said shell defining an enclosed interior area and having at least one door for accessing said interior area; and
a hanger element having a first portion and a rotatable hook, said first portion being lowerly adjacent said shell upper end and being configured to distribute a hanging force throughout said shell upper end, said rotatable hook being operatively coupled to said first portion and extending upwardly of said shell upper end;
wherein said rotatable hook is configured to attach to a generally horizontal pole and rotate at least about ninety degrees relative to said first portion, whereby said shell rotates between a configuration extending generally perpendicular to said pole and a configuration extending generally parallel to said pole.

17. The storage device of claim 16, wherein said door is a flap having three sides selectively coupled to said shell front face.

18. The storage device of claim 17, wherein at least one of a hook and loop fastener and a zipper selectively maintain said three sides of said flap coupled to said shell front face.

19. The storage device of claim 18, further comprising a fixed hook operatively coupled to said first portion and extending upwardly of said shell upper end, said fixed hook being configured to attach to a top end of a door.

20. The storage device of claim 19, wherein:
said generally horizontal pole is a closet pole;
said shell has a generally rectangular cross section sized to fit inside a closet when said shell extends generally perpendicular to said closet pole;
said enclosed interior area includes a plurality of compartments;
at least one compartment is sized to receive paperwork; and
at least one said compartment is upwardly adjacent another said compartment
